(19) United States
(12) Patent Application Publication
(10) Pub. No.: US 2013/0054834 A1
(43) Pub. Date: Feb. 28, 2013

(54) ROUTE SEARCH DEVICE, ROUTE SEARCH METHOD, AND ROUTE SEARCH PROGRAM

(71) Applicants: Tomohiro HASHIGUCHI, Inagi (JP); Kazuyuki Tajima, Yokosuka (JP); Yutaka Takita, Kawasaki (JP)

(72) Inventors: Tomohiro HASHIGUCHI, Inagi (JP); Kazuyuki Tajima, Yokosuka (JP); Yutaka Takita, Kawasaki (JP)

(73) Assignee: FUJITSU LIMITED, Kawasaki-shi (JP)

(21) Appl. No.: 13/490,853

(22) Filed: Jun. 7, 2012

(30) Foreign Application Priority Data
Aug. 31, 2011 (JP) 2011-189773

(51) Int. Cl. G06F 15/173

(52) U.S. Cl. 709/242

(57) ABSTRACT

The first route searching unit searches among multiple routes from a start node toward a goal node for a first route by using topology information. The topology information changing unit changes the topology information by excluding the first route from the multiple routes and setting, to configuration links constituting the first route, additional links whose direction is opposite to that of the configuration links. The port information changing unit changes port information such that communication in a direction from the goal node toward the start node is permitted in the configuration links and the additional links. The second route searching unit searches for a second route by using the changed topology information and the changed port information. The redundant route searching unit searches for a pair of redundant routes by eliminating the configuration links that overlap on the first route and the second route.

### CROSS-REFERENCE TO RELATED APPLICATION

This application is based upon and claims the benefit of priority of the prior Japanese Patent Application No. 2011-189773, filed on Aug. 31, 2011, the entire contents of which are incorporated herein by reference.

### FIELD

The embodiment discussed herein is directed to a route search device, a route search method, and a route search program.

### BACKGROUND

In recent years, to improve the reliability of networks, studies have been conducted on various kinds of route search methods of searching redundant routes used for detouring around a failure point if a node failure or a link failure occurs in the network. One example of a proposed route search method is a method of searching multiple routes from a start node toward a goal node in a network for a pair of redundant routes that do not overlap with each other.

Furthermore, networks used in recent years sometimes include a node that limits connections between ports (hereinafter, referred to as a “limit node”). If the route search method is used to search for a pair of redundant routes in a network that includes such a limit node, a route that includes a portion in which communication is limited may possibly be searched as if it is a redundant route. Accordingly, a search method has been proposed that excludes a route that conflicts with the connection limit between ports at a limit node from being a candidate for a redundant route.

With this route search method, by using topology information indicating the connection state between nodes in a network, a route search device searches among multiple routes from the start node toward the goal node for a first route for which the total cost of links in the first route is a minimum. Then, the route search device changes topology information by excluding the first route from the multiple routes. If a limit node that limits the connection between ports is included in the first route, the route search device changes port information indicating the limitations of the connection between the ports at the limit node such that a route that conflicts with the limitations is not searched as a pair of the redundant routes. Then, by using the changed topology information and the changed port information, the route search device searches for a second route that is different from the first route. Then, by eliminating the links that overlap in the first route and the second route, the route search device searches for a pair of redundant routes that are not overlapped with each other. Accordingly, even if a limit node is included in a network, it is possible to avoid erroneously searching for a redundant route that conflicts with the limitations of the connection between ports at the limit node.

Patent Document 1: Japanese Laid-open Patent Publication No. 2011-041017

However, with a conventional route search method that excludes routes that conflict with the limitations of the connection between ports at the limit node from being candidates for redundant routes, there is a problem in that a redundant route that includes links from the end point toward the starting point in a network may not be appropriately searched.

Specifically, with the conventional route search method, by changing the direction of the links constituting the first route to the direction from the goal node toward the start node, the first route is excluded from the multiple routes. Accordingly, with the conventional route search method, when a redundant route is searched, if links that overlap in the first route and the second route are eliminated, a link that has had its direction changed to the direction from the goal node toward the start node is cancelled out by configuration links that constitutes the first route and thus disappears. More specifically, with the conventional route search method, because a link from the goal node towards the start node disappears, a route, which includes links from the end point toward the starting point in a network that includes a limit node may not possibly be searched as a redundant route.

### SUMMARY

According to an aspect of an embodiment of the invention, a route search device includes a first route searching unit that searches among, by using topology information indicating a connection state between multiple nodes in a network in which the multiple nodes are connected by links, multiple routes from a start node toward a goal node in the network for a first route in which a total cost of the links is a minimum; a topology information changing unit changes the topology information by excluding the first route from the multiple routes and setting, to configuration links constituting the first route, additional links whose direction is opposite to a direction of the configuration links; a port information changing unit that changes, when a limit node that limits a connection between ports is included in the first route, port information indicating limitations of the connection between the ports at the limit node such that communication in a direction from the goal node toward the start node is permitted in the configuration links and the additional links; a second route searching unit that searches among the multiple routes for a second route that is different from the first route by using the changed topology information and the changed port information; and a redundant route searching unit that searches for a pair of redundant routes that do not overlap with each other by eliminating the configuration links that overlap on the first route and the second route.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram illustrating a route search method performed by a route search device according to an embodiment;

FIG. 2 is a block diagram illustrating the configuration of the route search device according to the embodiment;

FIG. 3 is a schematic diagram illustrating an example of a topology information storing unit;

FIG. 4 is a schematic diagram illustrating an example of a first route information storing unit;

FIG. 5 is a schematic diagram illustrating an example of the port information storing unit;

FIG. 6 is a schematic diagram illustrating an example of a second route information storing unit;

FIG. 7 is a schematic diagram illustrating an example of a redundant route information storing unit;

FIG. 8A is a schematic diagram illustrating a process performed by a topology information changing unit when a limit node is included in a first route;

FIG. 8B is a schematic diagram illustrating a process performed by the topology information changing unit when a normal node is included in the first route;

FIG. 9 is a schematic diagram illustrating an example of topology information changed by the topology information changing unit;

FIG. 10A is a schematic diagram illustrating a process performed by a port information changing unit;

FIG. 10B is a schematic diagram illustrating a process performed by the port information changing unit;

FIG. 10C is a schematic diagram illustrating a process performed by the port information changing unit;

FIG. 11 is a schematic diagram illustrating an example of port information changed by the port information changing unit;

FIG. 12 is a flowchart illustrating the flow of a route search process performed by the route search device according to the embodiment;

FIG. 13A is a schematic diagram illustrating an example of another process performed by the topology information changing unit;

FIG. 13B is a schematic diagram illustrating an example of another process performed by the topology information changing unit; and

FIG. 14 is a schematic diagram illustrating the hardware configuration of a computer that constitutes the route search device according to the embodiment.

### DESCRIPTION OF EMBODIMENT

Preferred embodiments of the present invention will be explained with reference to accompanying drawings.

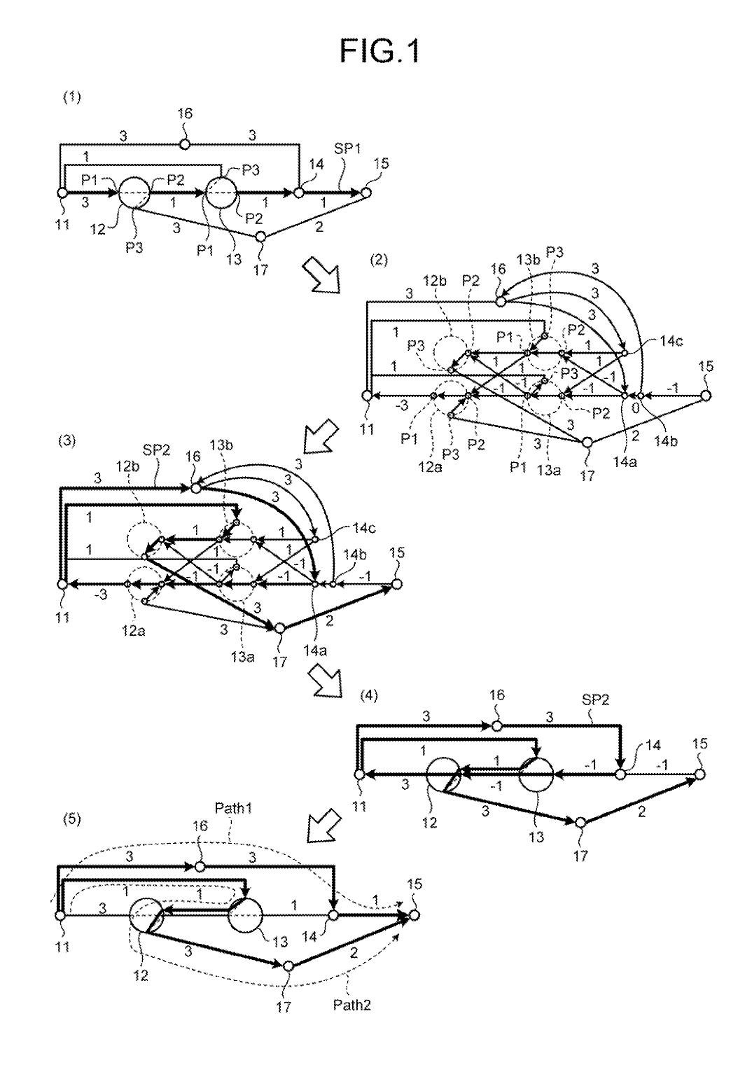

First, a route search method performed by the route search device according to the embodiment will be described. FIG. 1 is a schematic diagram illustrating a route search method performed by a route search device according to an embodiment. The network illustrated in FIG. 1 includes multiple nodes 11 to 17. The multiple nodes 11 to 17 are connected by links to each other. The numerals indicated near the links represent costs indicating the theoretical distances of the links. For example, the cost of the link that connects a node 14 and a node 16 is “3”.

Furthermore, from among the multiple nodes 11 to 17, the node 11 is a node functioning as a starting point and is called a start node. A node 15 is a node functioning as an end point and is called a goal node. Furthermore, a node 12 and a node 13 are nodes that limit a connection among ports P1 to P3 and are called limit nodes. In this case, it is assumed that communication between the node 13 and the start node 11 or between the node 13 and the node 17 are permitted by the limit node 12 and it is assumed that communication between the node 11 and the node 17 is limited by the limit node 12. Furthermore, it is assumed that the communication between the node 12 and the start node 11 or between the node 12 and the node 14 is permitted by the limit node 13 and it is assumed that communication between the start node 11 and the node 14 is limited by the limit node 13.

By using topology information indicating the connection state between nodes in the network, the route search device, first, searches among the multiple routes from the start node 11 to the goal node 15 in the network for a first route for which the total cost of the links is a minimum (see (1) of FIG. 1). In the example illustrated in FIG. 1, by using the topology information, the route search device searches for a route, for which the total cost of the links is a minimum of “6” and which will be a first route SP1. The first route SP1 that is searched for in this way is constituted by “the start node 11→the node 12→the node 13→the node 14→the goal node 15”.

Subsequently, the route search device excludes the first route SP1 from the multiple routes and sets, to configuration links constituting the first route SP1, additional links whose direction is opposite to the direction of the configuration links, thus changing the topology information (see (2) of FIG. 1). In the example illustrated in FIG. 1, the route search device reverses the direction of the configuration links constituting the first route SP1; inverts the signs of the costs of the configuration links; and excludes the first route SP1 from the multiple routes. Then, the route search device divides the limit node 12, the limit node 13, and the node 14 included in the first route SP1 into subnodes 12a and 12b, subnodes 13a and 13b, and subnodes 14a to 14c, respectively. Then, the route search device reverses the direction of the configuration links constituting the first route SP1 and sets additional links with respect to the configuration links constituting the first route SP1.

Subsequently, the route search device changes port information that indicates the limitations of the connection of the ports P1 to P3 at the limit nodes 12 and 13 such that communication from the goal node 15 toward the start node 11 is permitted in the configuration links and the additional links (see (2) of FIG. 1). In the example illustrated in FIG. 1, at the limit node 12a, for the connection between the ports P1 and P2 connecting the start-side node 11 and the goal-side node 13a, the route search device changes the port information by permitting communication in the direction from the goal-side node 13a toward the start-side node 11 along the configuration links. Furthermore, at the limit node 13a or the limit node 13b, for the connection between the ports P1 and P2 connecting the start-side node 12a and the goal-side node 14a, the route search device changes the port information by permitting communication in the direction from the goal-side node 14a toward the start-side node 12a along the configuration links. Furthermore, at the limit node 13a or the limit node 13b, for the connection between the ports P1 and P2 connecting the start-side node 12b and the goal-side node 14c, the route search device changes the port information by permitting communication in the direction from the goal-side node 14c toward the start-side node 12b along the additional link. Furthermore, at the limit node 13a or the limit node 13b, for the connection between the ports P1 and P2 connecting the goal-side node 14c and the start-side node 12a, the route search device changes the port information by permitting communication in the direction from the goal-side node 14c toward the start-side node 12a along the configuration links. Furthermore, at the limit node 13a or the limit node 13b, for the connection between the ports P1 and P2 connecting the goal-side node 14a and the start-side node 12b, the route search device changes the port information by permitting communication in the direction from the goal-side node 14a toward the start-side node 12b along the additional link.

Furthermore, at the limit node 12a, the connection between the ports P2 and P3 connecting the goal-side node 13a or 13b and the off-route node 17, the route search device changes the port information by permitting communication in the direction from the off-route node 17 towards the goal-side node 13a or 13b along the configuration links. Furthermore, at the limit node 12b, for the connection between the ports P2 and P3 connecting the goal-side node 13a or 13b and the off-route node 17, the route search device changes the port information by permitting communication in the direction from the goal-side node 13a or 13b toward the off-route node 17 along the additional link.

Furthermore, at the limit node 13a, for the connection among the ports P1 to P3 connecting the start-side node 12a and the off-route node 11, the route search device changes the port information by permitting communication in the direction from the start-side node 12a toward the off-route node 11 along the configuration links. Furthermore, at the limit node 13b, for the connection among the ports P1 to P3 connecting the start-side node 12b and the off-route node 11, the route search device changes the port information by permitting communication in the direction from the off-route node 11 toward the start-side node 12a along the additional link.

The start-side node mentioned here is a start node or a node that is present closer to the start node side than the limit node on the first route. The goal-side node mentioned here is the goal node of a node that is present closer to the goal node side than the limit node on the first route. Furthermore, the off-route node mentioned here is a node that is not included in the first route or a node that is not adjacent to the limit node from among the nodes included in the first route.

Subsequently, by using the changed topology information and the changed port information, the route search device searches among the multiple routes for a second route SP2 that is different from the first route SP1 (see (3) and (4) of FIG. 1). In the example illustrated in FIG. 1, by using the changed topology information and the changed port information, the route search device searches for a route which will be the second route SP2 and for which the total cost of the changed links is a minimum, i.e., “8”. The second route SP2 searched in this way is constituted by “the start node 11→the node 16→the node 14→the limit node 13→the limit node 12→the start node 11→the limit node 13→the limit node 12→the node 17→the goal node 15”.

Subsequently, the route search device eliminates the configuration links that overlap in the first route SP1 and the second route SP2, thereby searching for a pair of redundant routes that do not overlap with each other (see (5) of FIG. 1). In the example illustrated in FIG. 1, the route search device searches for, as the configuration links that overlap in the first route SP1 and the second route SP2, a pair of redundant route paths 1 and 2 by eliminating links connecting the limit node 12 and the limit node 13. The redundant route path 1 searched in this way is constituted by “the start node 11→the node 16→the node 14→the goal node 15”. Furthermore, the redundant route path 2 searched in this way is constituted by “the start node 11→the limit node 13→the limit node 12→the node 17→the goal node 15”.

Between the redundant route paths 1 and 2, the redundant route path 2 includes the limit nodes 12 and 13. However, the limit nodes 12 and 13 are appropriate redundant routes because they satisfy the connection limit of the ports P1 to P3 at the limit nodes 12 and 13. Furthermore, the redundant route path 2 includes links that connect limit node 13 and the limit node 12 as the links directed from the goal node 15 toward the start node 11 on the first route SP1.

As described above, the route search device according to the embodiment changes the topology information by excluding the first route from the multiple routes and setting an additional link whose direction is opposite to the direction of the configuration links that constitutes the first route. Then, the route search device changes the port information on the limit nodes such that communication from the goal node toward the start node in the configuration links and in the additional link is permitted. Then, by using the changed topology information and the changed port information, the route search device searches among the multiple routes for a second route that is different from the first route.

Accordingly, if the route search device according to the embodiment searches the first route and the second route for a pair of redundant routes, even if the route search device eliminates the configuration links that overlap in the first route and the second route, the route search device can keep the links from the goal node toward the start node in the first route. Specifically, the route search device according to the embodiment can appropriately search the network, which includes a limit node that limits a connection between ports, for a redundant route that includes a link from the end point toward the starting point in the first route.

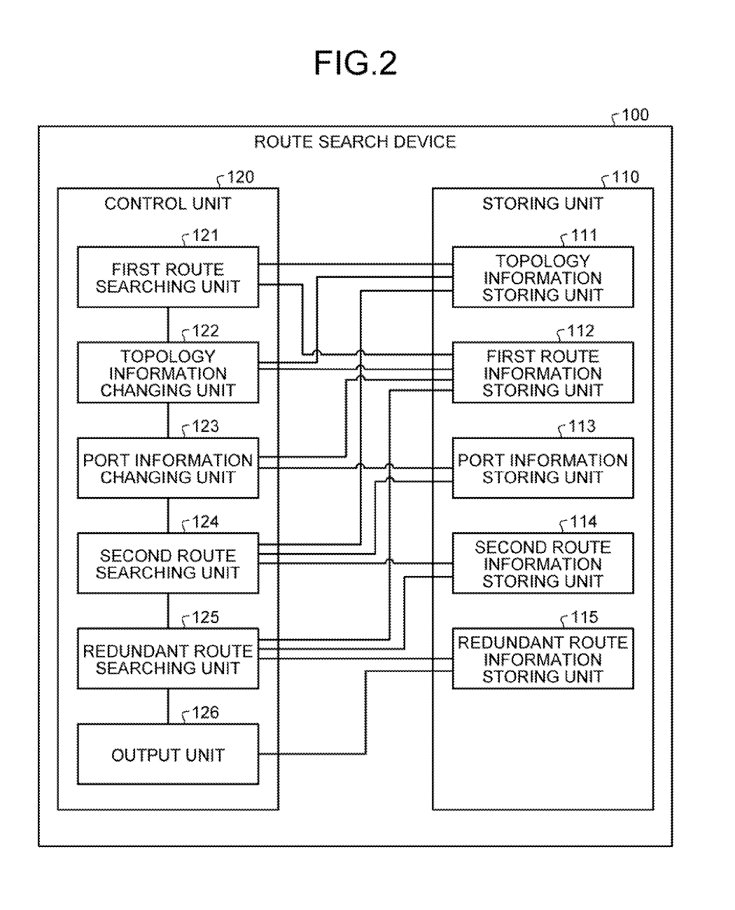

In the following, the configuration of the route search device according to the embodiment will be described with reference to FIG. 2. FIG. 2 is a block diagram illustrating the configuration of a route search device 100 according to the embodiment. As illustrated in FIG. 2, the route search device 100 includes a storing unit 110 and a control unit 120.

The storing unit 110 stores therein data needed for various processes performed by the control unit 120 and the results of the various processes performed by the control unit 120. The storing unit 110 includes a topology information storing unit 111, a first route information storing unit 112, a port information storing unit 113, a second route information storing unit 114, and a redundant route information storing unit 115.

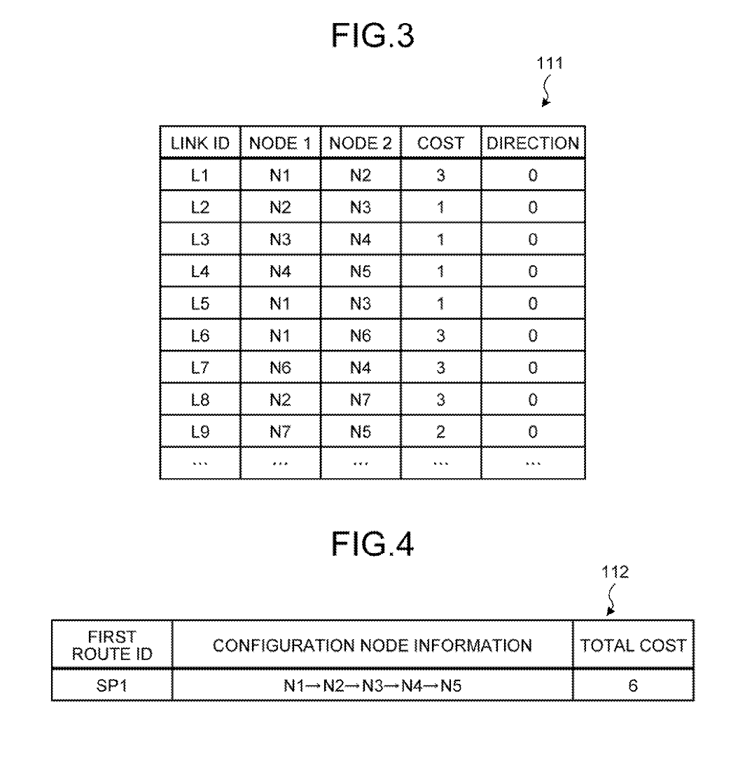

The topology information storing unit 111 stores therein topology information that indicates the connection state between the nodes in the network in which multiple nodes are connected by links. The topology information storing unit 111 stores therein, as the topology information, information that is input by a user of the route search device 100 or information collected from each node by a communication interface. FIG. 3 illustrates an example of the topology information storing unit 111. The topology information storing unit 111 illustrated in FIG. 3 stores therein, in an associated manner, items, such as a link identifier (ID), a node 1, a node 2, a cost, and a direction.

The link ID is identification information for identifying a link that connects nodes constituting the network. The node 1 is identification information on one node that is connected to one end of the link. The node 2 is identification information on the other node that is connected to the other end of the link. The cost is a theoretical distance of the link. The direction is a communication direction of the link. If the communication from the node 1 toward the node 2 and the communication from the node 2 toward the node 1 are permitted, the direction becomes “0”. Furthermore, if the communication from the node 1 toward the node 2 is permitted, the direction becomes “1”. In contrast, if the communication from the node 2 toward the node 1 is permitted, the direction becomes “2”.

The first route information storing unit 112 stores therein, as first route information, information on the first route that is searched from the multiple routes from the start node toward the goal node on the network. The first route information stored by the first route information storing unit 112 is created by a first route searching unit 121, which will be described later, and is then stored. FIG. 4 illustrates an example of the first route information storing unit 112. The first route information storing unit 112 illustrated in FIG. 4 stores therein, in an associated manner, items, such as a first route ID, a configuration node information, and a total cost.

The first route ID is identification information for identifying the first route. The configuration node information is identification information on nodes constituting the first route. For example, “N1→N2→N3→N4→N5” represents the nodes constituting the first route SP1 starting from a node N1 functioning as the start node to a node N5 functioning as the goal node via nodes N2, N3, and N4. The total cost is the total cost of the links included in the first route.

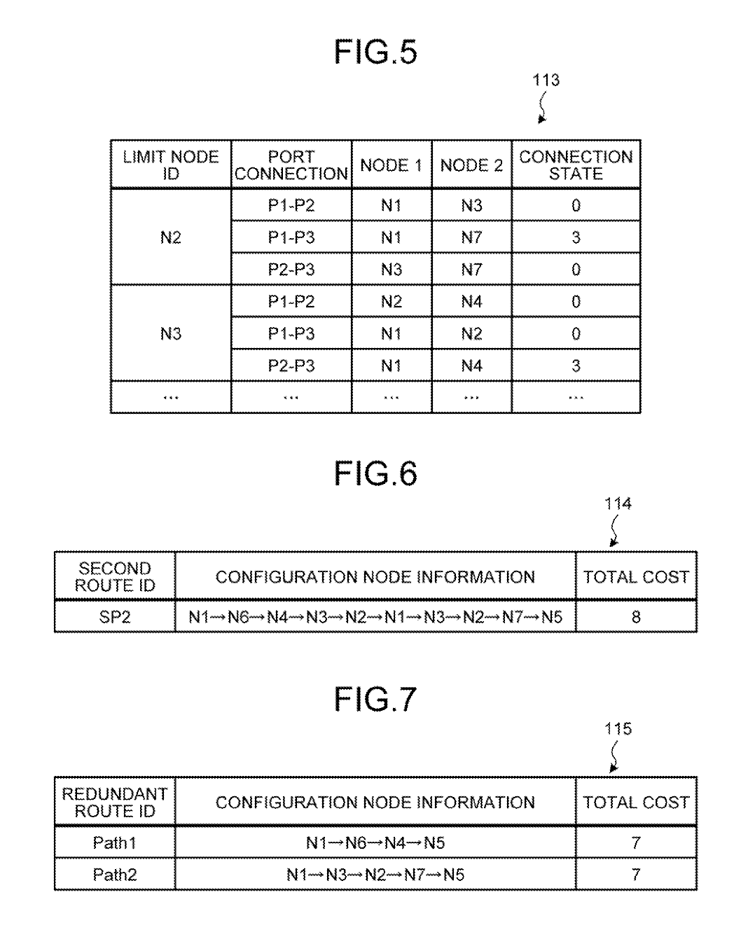

The port information storing unit 113 stores therein, as port information, information indicating the limitations of the connection between ports at a limit node. The port information storing unit 113 stores therein, as port information, information that is input by a user of the route search device 100 or information collected from each node by a communication interface. FIG. 5 illustrates an example of the port information storing unit 113. The port information storing unit 113 illustrated in FIG. 5 stores therein, in an associated manner, items, such as a limit node ID, a port connection, the node 1, the node 2, and the connection state.

The limit node ID is identification information for identifying a limit node. The port connection represents the connection between a given pair of ports from among the ports included in the limit node. For example, “P1-P2” represents the connection between the port P1 and the port P2. The node 1 is a node connected to one port between a pair of ports in the port connection. The node 2 is a node connected to the other port between the pair of ports in the port connection. The connection state indicates the connection state of the port connection. If the communication from the node 1 toward the node 2 and the communication from the node 2 toward the node 1 are permitted, the connection state becomes “0”. Furthermore, if the communication from the node 1 toward the node 2 is permitted, the connection state becomes “1”. If the communication from the node 2 toward the node 1 is permitted, the connection state becomes “2”. If the communication between the node 1 and the node 2 is limited, the connection state becomes “3”.

The second route information storing unit 114 stores therein, as second route information, information on the second route searched from the multiple routes from the start node toward the goal node in the network. The second route information stored by the second route information storing unit 114 is created by a second route searching unit 124, which will be described later, and is then stored. FIG. 6 illustrates an example of the second route information storing unit 114. The second route information storing unit 114 illustrated in FIG. 6 stores therein, in an associated manner, items, such as a second route ID, a configuration node information, and a total cost.

The second route ID is identification information for identifying the second route. The configuration node information is identification information on nodes constituting the second route. For example, “N1→N6→N4→N3→N2→N1→N3→N2→N7→N5” represents the nodes constituting the second route SP2 starting from a node N1 functioning as the start node to a node N5 functioning as the goal node via nodes N6, N4, N3, N2, N1, N3, N2, and N7. The total cost is the total cost of the links included in the second route.

The redundant route information storing unit 115 stores therein, as redundant route information, information on a pair of redundant routes that are searched from the multiple routes from the start node toward the goal node in the network and that are not overlapped with each other. The redundant route information stored by the redundant route information storing unit 115 is created by a redundant route searching unit 125, which will be described later, and is then stored. FIG. 7 illustrates an example of the redundant route information storing unit 115. The redundant route information storing unit 115 illustrated in FIG. 7 stores therein, in an associated manner, items, such as a redundant route ID, a configuration node information, and a total cost.

The redundant route ID is identification information for identifying a redundant route. The configuration node information is identification information on nodes constituting the redundant route. For example, “N1→N6→N4→N5” represents nodes constituting the redundant route path 1 starting from a node N1 functioning as the start node to a node N5 functioning as the goal node via nodes N6 and N4. The total cost is the total cost of the links included in the redundant route.

The control unit 120 includes an internal memory for storing various kinds of data and programs prescribing various kinds of procedures, whereby various kinds of processes are executed. Specifically, the control unit 120 includes the first route searching unit 121, a topology information changing unit 122, a port information changing unit 123, the second route searching unit 124, the redundant route searching unit 125, and an output unit 126.

By using the topology information, the first route searching unit 121 searches among the multiple routes from the start node toward the goal node in the network for the first route for which the total cost of links in the first route is a minimum. Specifically, the first route searching unit 121 reads the topology information from the topology information storing unit 111. Then, by applying a route search algorithm in a graph represented by the Dijkstra's algorithm to the read topology information, the first route searching unit 121 searches among the multiple routes for the first route for which the total cost of links in the first route is a minimum. Furthermore, the first route searching unit 121 stores, in the first route information storing unit 112, the searched information on the first route as the first route information.

The topology information changing unit 122 changes the topology information by excluding the searched first route from the multiple routes in the network and by setting, to configuration links constituting the first route, the additional links whose direction is opposite to the direction of the configuration links. Specifically, the topology information changing unit 122 reads, from the first route information storing unit 112, a configuration node, for example, the configuration node “N1→N2→N3→N4→N5”, in the searched first route having, for example, the first route ID of “SP1”. Then, the topology information changing unit 122 refers to the topology information storing unit 111, reverses the direction of the links connecting the read configuration node, i.e., reverses the direction of the configuration links constituting the first route, and inverts the signs of the cost of the configuration links. Accordingly, the first route is excluded from the multiple routes in the network. Then, the topology information changing unit 122 refers to the topology information storing unit 111 and divides the nodes included in the first route into multiple subnodes. Then, the topology information changing unit 122 reverses the direction of the configuration links constituting the first route. Accordingly, additional links are set with respect to the configuration links that constitutes the first route.

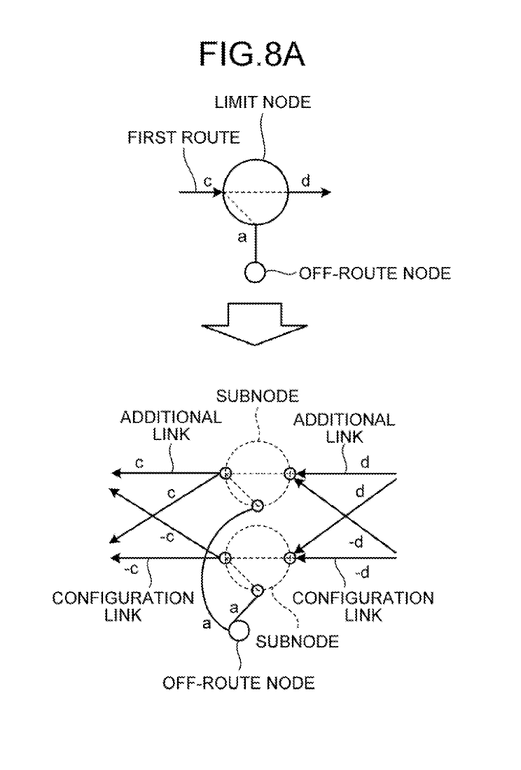

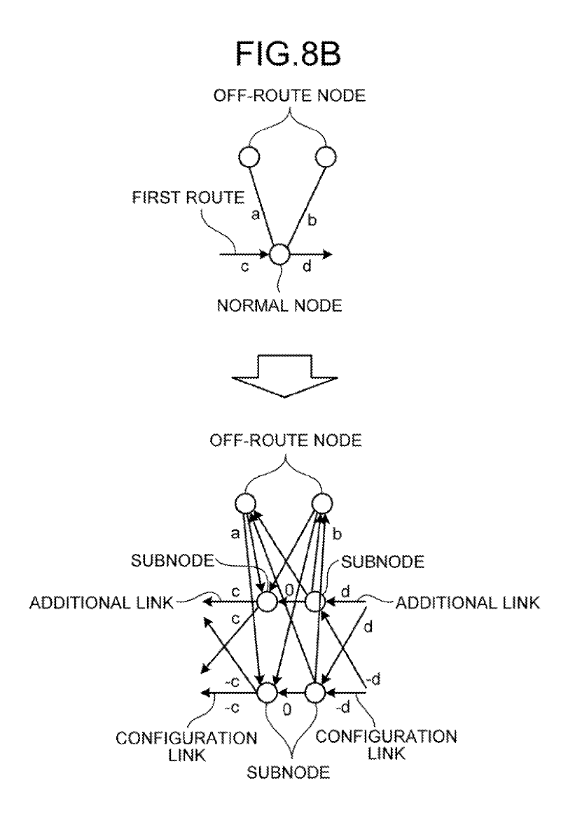

In the following, a method for changing the topology information performed by the topology information changing unit 122 will be specifically described. A process performed by the topology information changing unit 122 when a limit node is included in the first route will be described with reference to FIG. 8A first. FIG. 8A is a schematic diagram illustrating a process performed by the topology information changing unit 122 when a limit node is included on a first route.

As illustrated in FIG. 8A, the topology information changing unit 122 reverses the direction of the configuration links constituting the first route and inverts the signs of the costs “c” and “d” in the configuration links. Accordingly, the first route is excluded from the multiple routes in the network. Then, the topology information changing unit 122 divides the limit node included in the first route into two subnodes. Then, the topology information changing unit 122 reverses the direction of the configuration links constituting the first route. Accordingly, additional links are set with respect to the configuration links constituting the first route.

In the following, a process performed by the topology information changing unit 122 when a normal node is included in the first route will be described with reference to FIG. 8B. FIG. 8B is a schematic diagram illustrating a process performed by the topology information changing unit when a normal node is included on the first route. In the following, a node other than the limit node is sometimes referred to as a normal node.

As illustrated in FIG. 8B, the topology information changing unit 122 reverses the direction of the configuration links constituting the first route and inverts the signs of the costs “c” and “d” of the configuration links. Accordingly, the first route is excludes from the multiple routes on the network. Then, the topology information changing unit 122 divides the normal node included in the first route into four subnodes. Then, the topology information changing unit 122 reverses the direction of the configuration links constituting the first route. Accordingly, additional links are set with respect to the configuration links constituting the first route.

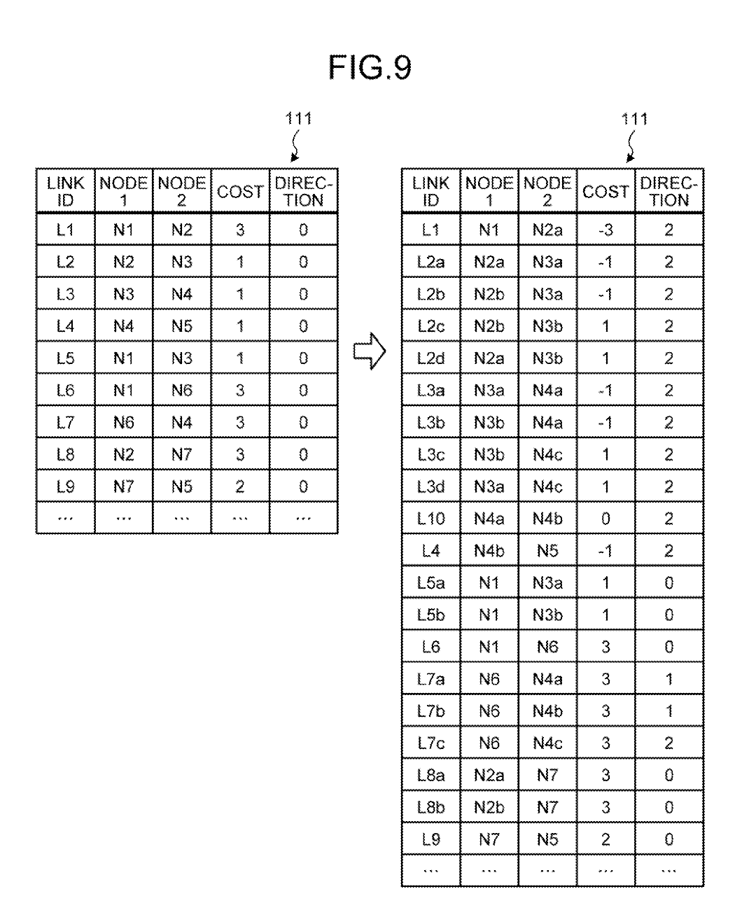

Specifically, the topology information changing unit 122, changes the topology information stored in the topology information storing unit 111 illustrated in FIG. 3 to the topology information illustrated on the right side of FIG. 9. More specifically, the topology information changing unit 122 reverses the direction of the configuration links having, for example, the link IDs of “L1”, “L2a”, “L2b”, “L3a”, “L3b”, and “L4” constituting the first route and inverts the signs of the costs of the configuration links. Accordingly, the first route is excluded from the multiple routes in the network. Then, the topology information changing unit 122 divides the limit nodes, for example, nodes “N2” and “N3”, included in the first route into two subnodes, for example, nodes “N2a” and “N2b” and nodes “N3a” and “N3b”. Furthermore, the topology information changing unit 122 divides the normal node, for example, node “N4”, included in the first route into three subnodes, for example, nodes “N4a”, “N4b”, and “N4c”. Then, the topology information changing unit 122 reverses the direction of the configuration links having, for example, link IDs of “L2c”, “L2d”, “L3c”, and “L3d” constituting the first route. Accordingly, additional links are set with respect to the configuration links constituting the first route. FIG. 9 is a schematic diagram illustrating an example of topology information changed by the topology information changing unit 122.

A description will be given here by referring back to FIG. 2. If a limit node is included in the first route, the port information changing unit 123 changes the port information such that communication from the goal node toward the start node is permitted in configuration links constituting the first route and additional links that are set in the configuration links. Specifically, the port information changing unit 123 reads, from the first route information storing unit 112, the configuration node, for example, configuration node “N1→N2→N3→N4→N5”, on the searched first route having, for example, the first route ID “SP1”.

Then, the port information changing unit 123 refers to the port information storing unit 113 and determines whether a limit node associated with limit nodes ID, for example, “N2” and “N3”, are included in the read configuration node, for example, the configuration node “N1→N2→N3→N4→N5”. If the limit node is included in the read configuration node, the port information changing unit 123 changes the port information stored in the port information changing unit 123.

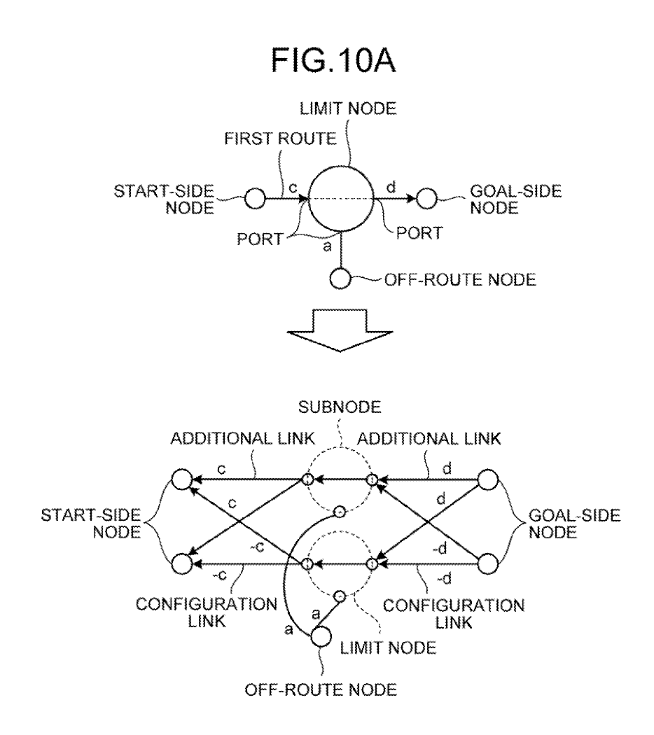

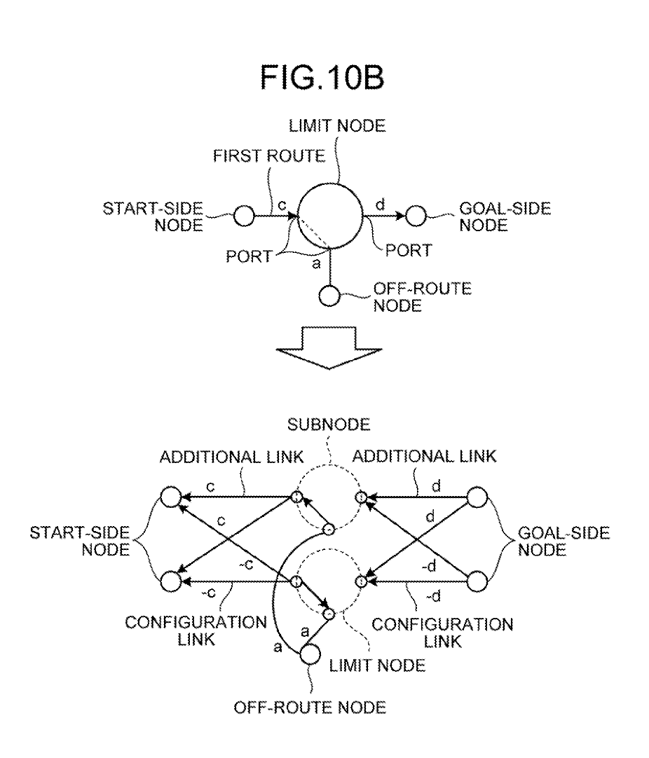

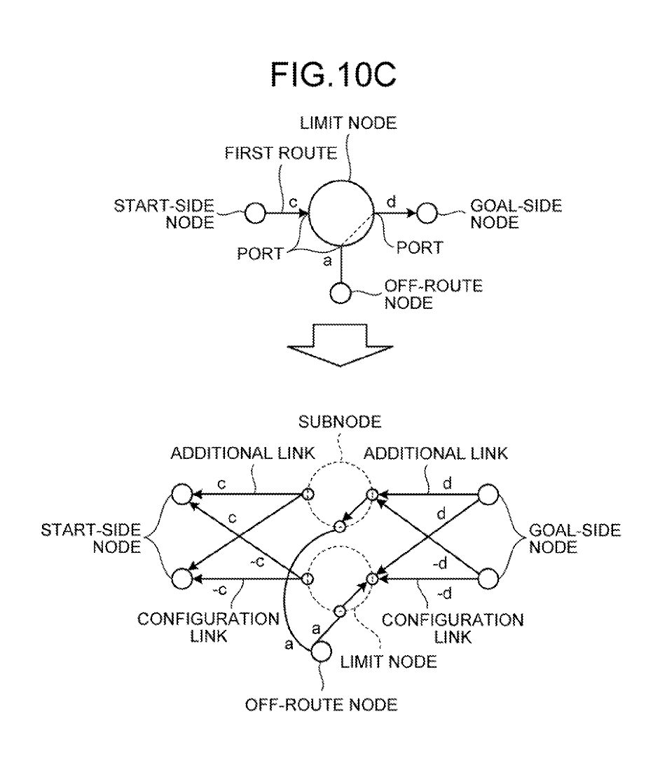

In the following, a method of changing port information performed by the port information changing unit 123 will be described with reference to FIGS. 10A to 10C. FIGS. 10A to 10C are schematic diagrams each illustrating a process performed by the port information changing unit 123.

As illustrated in FIG. 10A, for the connection between the ports connecting the start-side node and the goal-side node, the port information changing unit 123 changes the port information by permitting the direction from the goal-side node toward the start-side node along the configuration links and the additional links. At this time, if the second route uses the connection created at the subnode, the second route needs to use the connection from the goal-side node toward the start-side node in the limit node. In other words, if the second route uses an additional link, the second route also needs to use a configuration link.

As illustrated in FIG. 10B, for the connection between the ports connecting the start-side node and the off-route node, the port information changing unit 123 changes the port information by permitting the direction from the start-side node toward the off-route node along the configuration links. Furthermore, the port information changing unit 123 changes the port information by permitting communication in the direction from the off-route node toward the start-side node along the additional links. At this time, if the second route uses the connection between the off-route node and the start-side node in the subnode or the limit node, the second route also needs to use the connection from the goal-side node toward the start-side node in the limit node. Specifically, if the second route uses an additional link, the second route also needs to use a configuration link associated with the additional link. Furthermore, if the second route uses a link between a limit node and an off-route node, an immediately before node needs to be a goal-side neighboring node (including a subnode) on the first route.

Furthermore, as illustrated in FIG. 10C, for the connection between the ports connecting the goal-side node and the off-route node, the port information changing unit 123 changes the port information by permitting communication in the direction from the off-route node toward the goal-side node along the configuration links. Furthermore, the port information changing unit 123 changes the port information by permitting communication in the direction from the goal-side node toward the off-route node along the additional links. In this case, if the second route uses the connection between the off-route node and the goal-side node at the subnode or the limit node, the second route also needs to use the connection from the goal-side node toward the start-side node in the limit node. Specifically, if the second route uses an additional link, the second route also needs to use a configuration link associated with the additional link. Furthermore, if the second route uses a link between the limit node and the off-route node, an immediately after node needs to be a start-side neighboring node (including a subnode) on the first route.

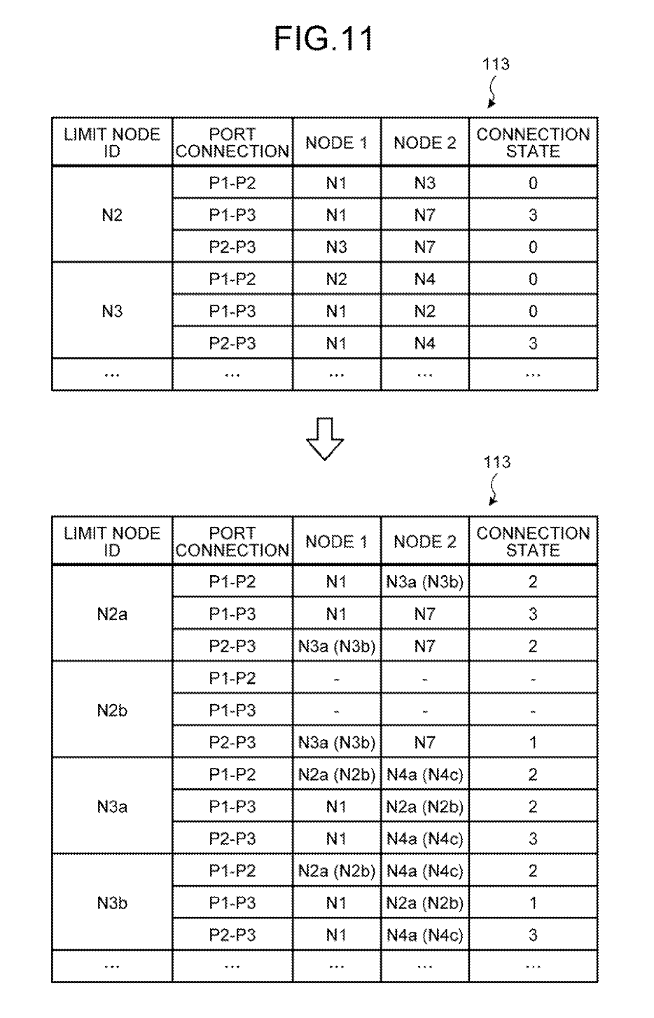

Specifically, the port information changing unit 123 changes the connection state indicated by the port information stored in the port information storing unit 113 illustrated in FIG. 5 to the port information illustrated in the lower portion of FIG. 11. More specifically, the port information changing unit 123 sets the connection state associated with the connection between the ports (port connection “P1-P2”) connecting the start-side node (node 1 “N1”) and the goal-side node (node 2 “N3a”) to “2” that indicates the configuration links of the goal-side node→the start-side node along the configuration links. Furthermore, the port information changing unit 123 sets the connection state associated with the connection between the ports (port connection “P1-P2”) connecting the start-side node (node 1 “N2a”) and the goal-side node (node 2 “N4a”) to “2” that indicates the configuration links of goal-side node→start-side node along the configuration links. Furthermore, the port information changing unit 123 sets the connection state associated with the connection between the ports (port connection “P1-P2”) connecting the start-side node (node 1 “N2b”) and the goal-side node (node 2 “N4c”) to “2” that indicates the configuration links of goal-side node→start-side node along the additional links.

Furthermore, the port information changing unit 123 sets the connection state associated with the connection between the ports (port connection “P2-P3”) connecting the goal-side node (node 1 “N3a”) and the off-route node (node 2 “N7”) to “2” that indicates the configuration links of off-route node→goal-side node along the configuration links. Furthermore, the port information changing unit 123 sets the connection state associated with the connection between the ports (port connection “P2-P3”) connecting the goal-side node (node 1 “N3b”) and the off-route node (node 2 “N7”) to “1” that indicates the configuration links of goal-side node→off-route node along the additional links.

Furthermore, the port information changing unit 123 sets the connection state associated with the connection between the ports (port connection “P1-P3”) connecting the off-route node (node 1 “N1”) and the start-side node (node 2 “N2a”) to “2” that indicates the configuration links of start-side node→off-route node along the configuration links. Furthermore, the port information changing unit 123 sets the connection state associated with the connection between the ports (port connection “P1-P3”) connecting the off-route node (node 1 “N1”) and the start-side node (node 2 “N2b”) to “1” that indicates the configuration links of off-route node→start-side node along the additional links. FIG. 11 is a schematic diagram illustrating an example of port information changed by the port information changing unit.

A description will be given here by referring back to FIG. 2. By using the topology information changed by the topology information changing unit 122 and the port information changed by the port information changing unit 123, the second route searching unit 124 searches for the second route among the multiple routes from the start node toward the goal node in the network. Specifically, the second route searching unit 124 reads, from the topology information storing unit 111, the topology information changed by the topology information changing unit 122. Then, the second route searching unit 124 reads, from the port information storing unit 113, the port information changed by the port information changing unit 123.

Then, by applying a route search algorithm in a graph represented by the Dijkstra's algorithm to the read topology information and the port information, the second route searching unit 124 searches among the multiple routes for a second route for which the total cost of links in the second route is a minimum. Furthermore, the second route searching unit 124 stores the searched information on the second route in the second route information storing unit 114 as the second route information.

By eliminating the configuration links that overlap in the first route and the second route, the redundant route searching unit 125 searches for a pair of redundant routes that do not overlap with each other. Specifically, the redundant route searching unit 125 reads a configuration node on the first route from the first route information storing unit 112. Then, the redundant route searching unit 125 reads a configuration node on the second route from the second route information storing unit 114. Then, the redundant route searching unit 125 compares the read configuration node on the first route with the read configuration node on the second route and specifies configuration links that overlap on the first route and the second route. Then, the redundant route searching unit 125 eliminates the specified configuration links from the configuration node on the first route and on the second route and joins the rest of the configuration links. Accordingly, a pair of redundant routes that do not overlap with each other is searched.

In the following, a process performed by the redundant route searching unit 125 will be described using an example each illustrated in FIGS. 4 and 6. The redundant route searching unit 125 reads, from the first route information storing unit 112, the configuration node “N1→N2→N3→N4→N5” of the first route ID “SP1”. Then, the redundant route searching unit 125 reads, from the second route information storing unit 114, the configuration node “N1→N6→N4→N3→N2→N1→N3→N2→N7→N5” of the second route ID “SP2”. Then, the redundant route searching unit 125 compares the read configuration node on the first route with the configuration node on the second route and specifies configuration links between the node “N2” and the node “N3” as the configuration links that overlap on the first route and the second route. Then, the redundant route searching unit 125 eliminates the specified configuration links between the node “N2” and the node “N3” and joins the rest of the configuration links. Accordingly, a pair of redundant routes that do not overlap with each other is searched. Then, the redundant route searching unit 125 stores the information on the searched pair of the redundant routes in the redundant route information storing unit 115 as the redundant route information.

The output unit 126 outputs the redundant route information stored in the redundant route information storing unit 115 as the processing results to a display unit, such as a display.

The first route searching unit 121, the topology information changing unit 122, the port information changing unit 123, the second route searching unit 124, the redundant route searching unit 125, and the output unit 126 included in the control unit 120 are, for example, integrated circuits or electronic circuits. Examples of the integrated circuit include an application specific integrated circuit (ASIC) or a field programmable gate array (FPGA). Examples of the electronic circuit include a central processing unit (CPU) or a micro processing unit (MPU).

The topology information storing unit 111, the first route information storing unit 112, the port information storing unit 113, the second route information storing unit 114, and the redundant route information storing unit 115 included in the storing unit 110 are, for example, semiconductor memory devices or storage devices. Examples of the semiconductor memory device include a random access memory (RAM), a read only memory (ROM), and a flash memory. Examples of the storage device include a hard disc drive (HDD) and an optical disk.

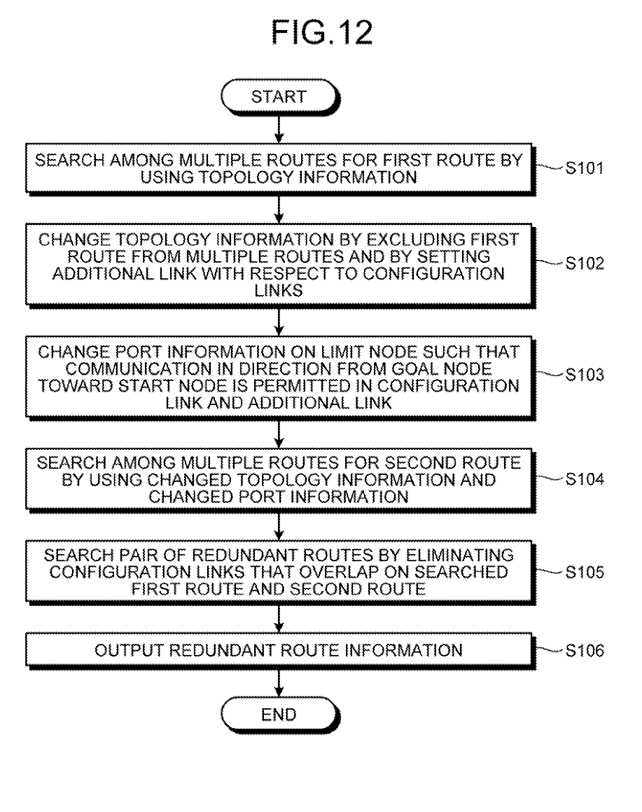

In the following, the flow of a route search process performed by the route search device 100 according to the embodiment will be described with reference to FIG. 12. FIG. 12 is a flowchart illustrating the flow of a route search process performed by the route search device 100 according to the embodiment.

As illustrated in FIG. 12, the first route information storing unit 112 searches among, using the topology information, the multiple routes from the start node toward the goal node for a first route for which the total cost of links in the first route is a minimum (Step S101).

Then, the topology information changing unit 122 changes the topology information by excluding the first route from the multiple routes and by setting an additional link whose direction is opposite to that of the configuration links constituting the first route (Step S102).

Then, the port information changing unit 123 changes the port information indicating the limitations of the port connection at a limit node such that communication in the direction from the goal node toward the start node is permitted in configuration links and additional links (Step S103). Then, by using the changed topology information and the changed port information, the second route searching unit 124 searches among the multiple routes for a second route that is different from the first route (Step S104).

Then, by eliminating the configuration links that overlap on the searched first route and the searched second route, the redundant route searching unit 125 searches a pair of redundant routes that do not overlap with each other (Step S105). Then, the redundant route searching unit 125 stores the information on the searched pair of redundant routes in the redundant route information storing unit 115 as the redundant route information. Then, the output unit 126 outputs and displays the redundant route information stored in the redundant route information storing unit 115 (Step S106).

As described above, the route search device 100 according to the embodiment changes the topology information by excluding a first route from the multiple routes and by setting an additional link whose direction is opposite to the direction of the configuration links constituting the first route. Then, the route search device 100 changes the port information on the limit node such that communication in the direction from the goal node toward the start node is permitted in the configuration link and the additional link. Then, by using the changed topology information and the port information, the route search device 100 searches among the multiple routes for a second route that is different from the first route.

Accordingly, when the route search device 100 according to the embodiment searches among the first route and the second route for a pair of redundant routes, the route search device 100 can keep an additional link from the goal node toward the start node even if the route search device 100 eliminates the configuration links that overlap on the first route and the second route. Specifically, the route search device 100 according to the embodiment can appropriately search the network, which includes a limit node that limits a connection between ports, for a redundant route that includes links from the end point toward the starting point.

In the above embodiment, a description has been given of a case in which, if a limit node is included in the first route, the port information changing unit 123 changes the port information such that communication in the direction from the goal node to the start node is permitted in configuration links and additional links. However, if the limit node is included in the first route, a method that permits communication in the direction from goal node toward the start node in the configuration links and the additional links is not limited thereto. For example, if the limit node is included in the first route, the topology information changing unit 122 may also change the topology information such that communication in the direction from the goal node toward the start node is permitted in the configuration links and the additional links.

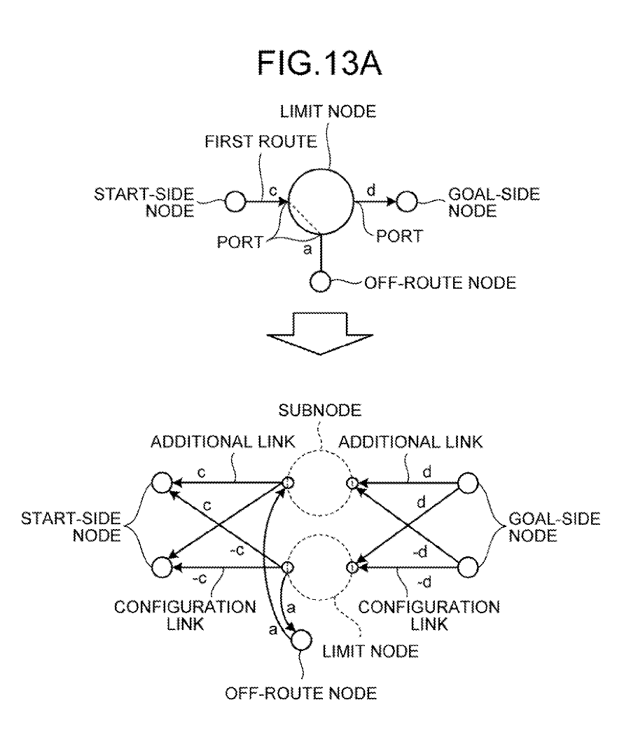

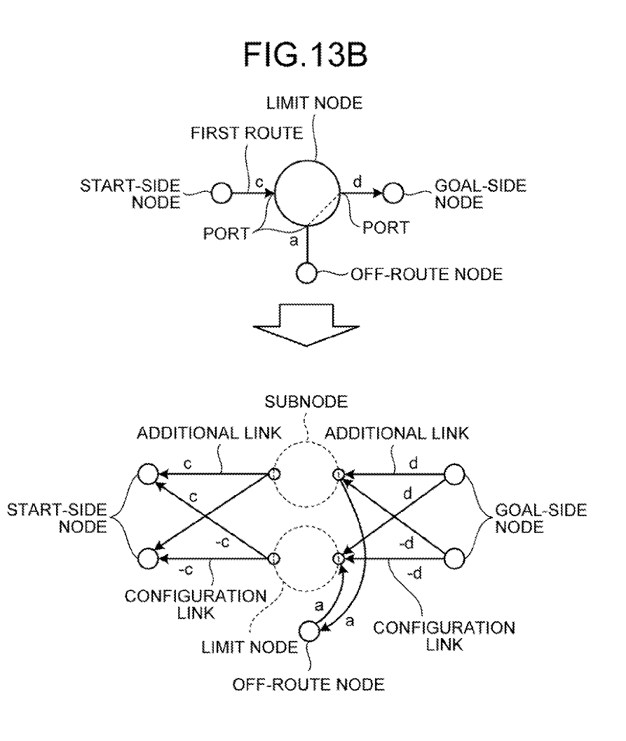

In the following, an example of another process performed by the topology information changing unit 122 will be described with reference to FIGS. 13A and 13B. FIGS. 13A and 13B are schematic diagrams each illustrating an example of another process performed by the topology information changing unit 122.

If a limit node is included in the first route, the topology information changing unit 122 changes the topology information as follows. As illustrated in FIG. 13A, for the connection between the ports connecting the start-side node and the off-route node, the topology information changing unit 122 changes the topology information by creating a new link directed from the start-side node toward the off-route node along the configuration links. Furthermore, the topology information changing unit 122 changes the topology information by creating a new link directed from the off-route node forward the start-side node along the additional links.

Furthermore, as illustrated in FIG. 13B, for the connection between the ports connecting the goal-side node and the off-route node, the topology information changing unit 122 changes the topology information by creating a new link directed from the off-route node toward the goal-side node along the configuration link. Furthermore, the topology information changing unit 122 changes the topology information by creating a new link directed from the goal-side node toward the off-route node along the additional link.

The route search device 100 can implement the various processes described in the embodiment by executing a program prepared in advance by a computer. Accordingly, in the following, a computer that executes a program having the same function performed by the device in the above embodiment will be described.

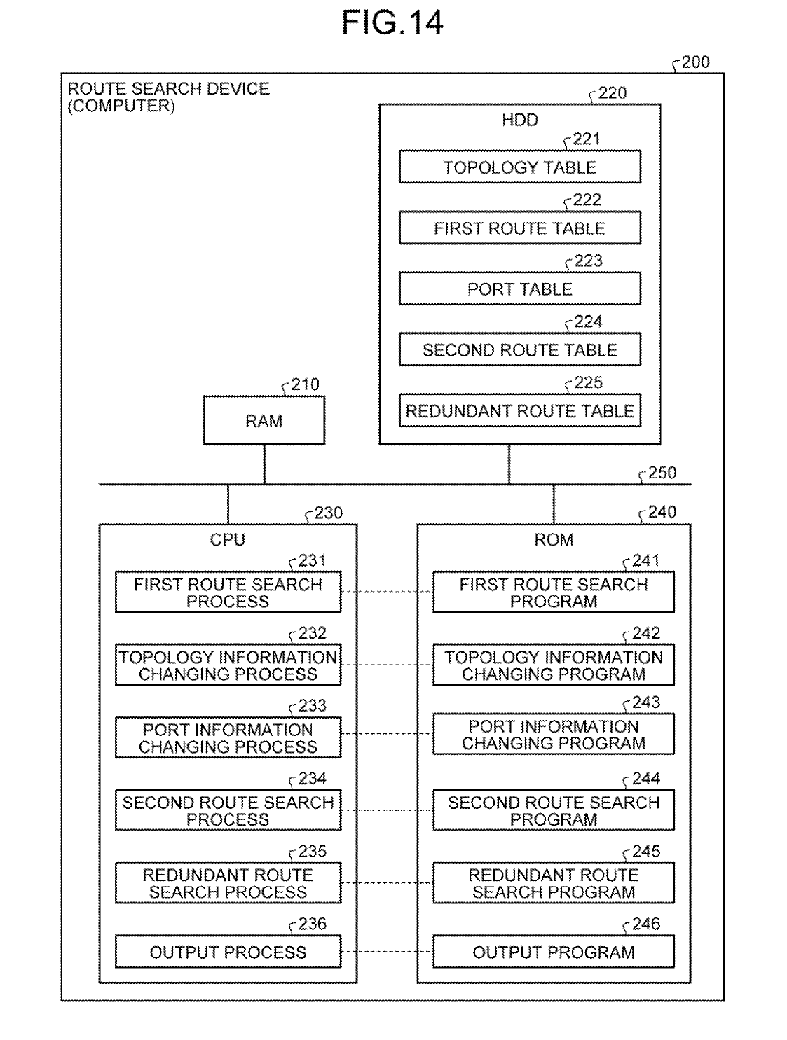

FIG. 14 is a schematic diagram illustrating the hardware configuration of a computer that constitutes the route search device according to the embodiment. As illustrated in FIG. 14, a computer 200 includes a RAM 210, an HDD 220, a CPU 230, and a ROM 240. Each of the devices 210 to 240 are connected to a bus 250.

The ROM 240 stores therein, in advance, a program having the same function as that in the embodiment. Specifically, the ROM 240 stores therein, in advance, a first route search program 241, a topology information changing program 242, a port information changing program 243, a second route search program 244, a redundant route search program 245, and an output program 246.

Then, the CPU 230 reads these programs 241 to 244 and executes them so that these programs 241 to 244 can function as a first route search process 231, a topology information changing process 232, a port information changing process 233, and a second route search process 234. Furthermore, the CPU 230 reads these programs 245 and 246 and executes them so that these programs 245 and 246 can function as a redundant route search process 235 and an output process 236. These processes 231 to 236 correspond to the first route searching unit 121, the topology information changing unit 122, the port information changing unit 123, the second route searching unit 124, the redundant route searching unit 125, and the output unit 126, respectively, illustrated in FIG. 2.

The HDD 220 stores therein a topology table 221, a first route table 222, a port table 223, a second route table 224, and a redundant route table 225. These tables 221 to 225 correspond to the topology information storing unit 111, the first route information storing unit 112, the port information storing unit 113, the second route information storing unit 114, and the redundant route information storing unit 115, respectively, illustrated in FIG. 2.

The programs 241 to 246 are not always stored in the ROM 240. For example, the computer 200 may also read these programs stored in a storage medium, such as a CD-ROM, and executes them. Furthermore, these programs may also be stored in, for example, a public circuit, the Internet, a local area network (LAN), and a wide area network (WAN). The computer 200 then reads and executes these programs from the above.

According to an aspect of the route search device disclosed in the present invention, an advantage is provided in that it is possible to search a network, which includes a limit node that limits a connection between ports, for a redundant route that includes links from the end point toward the starting point.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A route search device comprising:
a first route searching unit that searches among, by using topology information indicating a connection state between multiple nodes in a network in which the multiple nodes are connected by links, multiple routes from a start node toward a goal node in the network for a first route in which a total cost of the links is a minimum;
a topology information changing unit that changes the topology information by excluding the first route from the multiple routes and setting, to configuration links constituting the first route, additional links whose direction is opposite to a direction of the configuration links;
a port information changing unit that changes, when a limit node that limits a connection between ports is included in the first route, port information indicating limitations of the connection between the ports at the limit node such that communication in a direction from the goal node toward the start node is permitted in the configuration links and the additional links;
a second route searching unit that searches among the multiple routes for a second route that is different from the first route by using the changed topology information and the changed port information; and
a redundant route searching unit that searches for a pair of redundant routes that do not overlap with each other by eliminating the configuration links that overlap on the first route and the second route.

2. The route search device according to claim 1, wherein, for a connection between ports connecting a start-side node, which is present closer to the start node than the limit node on the first route, and a goal-side node, which is present closer to the goal node than the limit node on the first route, the port information changing unit changes the port information by permitting communication in a direction from the goal-side node toward the start-side node along the configuration links and the additional links.

3. The route search device according to claim 2, wherein, when the second route to be searched uses a connection created at a subnode, the second route searching unit uses a connection from the goal-side node toward the start-side node in the limit node.

4. The route search device according to claim 2, wherein, for a connection between ports connecting the start-side node and an off-route node that is not included in the first route, the port information changing unit changes the port information by permitting communication in a direction from the start-side node to the off-route node along the configuration links and by permitting communication in a direction from the off-route node to the start-side node along the additional links.

5. The route search device according to claim 4, wherein, when the second route to be searched uses a connection between the start-side node and a subnode or the off-route node that is in the limit node, the second route searching unit uses a connection from the goal-side node toward the start-side node in the limit node.

6. The route search device according to claim 4, wherein, for a connection between ports connecting the goal-side node and the off-route node, the port information changing unit changes the port information by permitting communication in a direction from the off-route node toward the goal-side node along the configuration links and by permitting communication in a direction from the goal-side node toward the off-route node along the additional links.

7. The route search device according to claim 6, wherein, when the second route to be searched uses a connection between the goal-side node and a subnode or the off-route node that is in the limit node, the second route searching unit uses a connection from the goal-side node toward the start-side node in the limit node.

8. A route search method causing a computer to execute a process comprising:
searching among, by using topology information indicating a connection state between multiple nodes in a network in which the multiple nodes are connected by links, multiple routes from a start node toward a goal node in the network for a first route in which a total cost of the links is a minimum;
changing the topology information by excluding the first route from the multiple routes and by setting, to configuration links constituting the first route, additional links whose direction is opposite to a direction of the configuration links;
changing, when a limit node that limits a connection between ports is included in the first route, port information indicating limitations of the connection between the ports at the limit node such that communication in a direction from the goal node toward the start node is permitted in the configuration links and the additional links;
searching among the multiple routes for a second route that is different from the first route by using the changed topology information and the changed port information; and
searching for a pair of redundant routes that do not overlap with each other by eliminating the configuration links that overlap on the first route and the second route.

9. A non-transitory computer readable storage medium having stored therein a route search program causing a computer to execute a process comprising:
searching among, by using topology information indicating a connection state between multiple nodes in a network in which the multiple nodes are connected by links, multiple routes from a start node toward a goal node in the network for a first route in which a total cost of the links is a minimum;
changing the topology information by excluding the first route from the multiple routes and by setting, to configuration links constituting the first route, additional links whose direction is opposite to a direction of the configuration links;
changing, when a limit node that limits a connection between ports is included in the first route, port information indicating limitations of the connection between the ports at the limit node such that communication in the direction from the goal node toward the start node is permitted in a configuration links and the additional links;
searching among the multiple routes for a second route that is different from the first route by using the changed topology information and the changed port information; and
searching for a pair of redundant routes that do not overlap with each other by eliminating the configuration links that overlap on the first route and the second route.

10. A route search device comprising:
a memory; and
a microprocessor coupled to the memory,
wherein the microprocessor is programmed to perform a process comprises
searching among, by using topology information indicating a connection state between multiple nodes in a network in which the multiple nodes are connected by links, multiple routes from a start node toward a goal node in the network for a first route in which a total cost of the links is a minimum;
changing the topology information by excluding the first route from the multiple routes and by setting, to configuration links constituting the first route, additional links whose direction is opposite to a direction of the configuration links;
changing, when a limit node that limits a connection between ports is included in the first route, port information indicating limitations of the connection between the ports at the limit node such that communication in a direction from the goal node toward the start node is permitted in the configuration links and the additional links;
searching among the multiple routes for a second route that is different from the first route by using the changed topology information and the changed port information; and
searching for a pair of redundant routes that do not overlap with each other by eliminating the configuration links that overlap on the first route and the second route.
